(19) United States
(12) Patent Application Publication
(10) Pub. No.: US 2020/0376509 A1
(43) Pub. Date: Dec. 3, 2020

(54) COSMETIC CONTAINER HAVING PUSH BUTTON BLOCKED FROM BEING PUSHED WITHIN REGULATION ANGLE

(71) Applicant: PUM-TECH KOREA CO., LTD, Inchen (KR)

(72) Inventor: Do Hoon LEE, Incheon (KR)

(21) Appl. No.: 16/960,520

(22) PCT Filed: Dec. 24, 2018
(86) PCT No.: PCT/KR2018/016498

§ 371 Date: Jul. 7, 2020

(30) Foreign Application Priority Data
Jan. 8, 2018 (KR) 10-2018-0002047

(51) Int. Cl. B05B 11/00; A45D 40/00; A45D 34/00

(52) U.S. Cl. CPC B05B 11/0027; A45D 40/00; A45D 2200/056; B05B 11/3052; B05B 11/3001; A45D 34/00

(57) ABSTRACT

The present invention relates to a cosmetic container having a push button blocked from being pushed within a regulation angle and, more specifically, to a cosmetic container having a push button blocked from being pushed within a regulation angle, wherein the pushing of the push button is allow or not allowed by the rotation of a rotating member; when the rotating member is rotated, the push button remains unable to be pushed within a predetermined rotation angle and thus can be prevented from being pushed by an undiscerning child; and when the rotating member is rotated beyond the predetermined rotation angle by an adult woman relatively stronger than the child, the push button is fixed in a pushable state so that a user can conveniently operate and use the cosmetic container.

### BACKGROUND OF THE INVENTION

### 1. Field of the Invention

The present invention relates to a cosmetic container having a push button blocked from being pushed within a regulation angle and, more specifically, to a cosmetic container having a push button blocked from being pushed within a regulation angle, wherein the pushing of the push button is allow or not allowed by the rotation of a rotating member; when the rotating member is rotated, the push button remains unable to be pushed within a predetermined rotation angle and thus can be prevented from being pushed by an undiscerning child; and when the rotating member is rotated beyond the predetermined rotation angle by an adult woman relatively stronger than the child, the push button is fixed in a pushable state so that a user can conveniently operate and use the cosmetic container.

### 2. Description of the Related Art

In general, women use various cosmetics to make up appearance more beautiful.

Based on the purpose of use, the cosmetics are classified into facial cleansing cosmetics used for removing sebum, wastes and contaminants on a surface of a skin, base cosmetics used for properly supplying moisture and oil to the skin, color cosmetics used for expressing beautiful colors, hair cosmetics used for protecting hairs and supplying nutrition as well as removing foreign substances from hairs or scalp, and perfumes obtained by dissolving fragrant materials in alcohol or the like and used for giving a fragrance to others.

As the above cosmetics have been developed, development of various cosmetics containers for containing cosmetic materials also has been required.

A liquid or gel cosmetic material having a viscosity among the above cosmetics is generally stored in a cosmetic container such as a tube container or a rigid plastic or glass container. For make-up, the cosmetic material is used in a manner that the cosmetic material is applied onto a skin by using a cosmetic tool, such as a puff, or a hand after the cosmetic container is pressed or turned over to discharge the cosmetic material to the hand of a user.

However, according to the conventional cosmetic container, it is difficult to constantly adjust the discharged amount of the cosmetic material, thereby causing waste of the cosmetic material. In addition, the cosmetic material stored in the cosmetic container is contaminated after coming into contact with external air or foreign matter.

Accordingly, recently a cosmetic container, which is configured to discharge contents in the container to the outside when the discharge pump is pumped by pressing the button after installing a discharge pump and a button to an inlet of the container containing a cosmetic material, has been developed and widely used.

However, when the cosmetic container equipped with the button and the discharge pump as described above is carried in a bag or the like, the button is pushed and the contents are discharged in an unintentional state of the user, or the button is pushed by an undiscerning child to discharge the contents, and accordingly, surroundings become dirty and the cosmetic material is wasted.

To solve the above mentioned problems, as shown in FIG. 1, Korean Patent Registration No. 10-1325527 discloses a dispenser container having a safety button structure. The above related art has a structure in which a pumping member, a button member and a rotating body are provided at an upper portion of a container, so that contents are discharged to the outside while the button member moves up and down only when the rotating body is rotated.

However, according to the above related art, since the contents are pumped and discharged to the outside only when the button member is pushed in a state where a user holds a container body with one hand and rotates the rotating body with the other hand, it is very uncomfortable in use.

In addition, according to the above related art, since a restoration spring is installed to restore the rotated rotating body to an initial position, the rotating body is required to be strongly rotated to a predetermined angle to allow the button part member to be pushed. Thus, an undiscerning child is restricted to use the container, but it is also uncomfortable for a woman, as an actual user, having a relatively weak strength to use the container.

### SUMMARY OF THE INVENTION

To solve the above problems, the present invention provides a cosmetic container for allowing a discharge device to be operated by pressing a push button to discharge cosmetic materials, wherein a fixing member is coupled to one side of the container body, a rotating member is rotatably coupled to the outside of the fixing member, and first and second regulation members are formed between the fixing member and the rotating member, in which each of the first and second regulation members is formed with a regulation protrusion including a regulation ridge and a regulation root so that the first and second regulation members are engaged with each other, the regulation protrusion of the first regulation member elastically comes into close contact with the regulation protrusion of the second regulation member by the elastic member the first regulation member coupled to the fixing member is fixed, upon rotation of the rotating member, and only the second regulation member coupled to the rotating member is rotated, and wherein the second regulation ridge of the second regulation member is prevented from passing over the first regulation ridge of the first regulation member and the second regulation member returns to an initial position, thereby maintaining a state of the push button prevented from being pushed, so that the push button is prevented from being pushed by an undiscerning child. Further, when the rotating member is rotated beyond the predetermined rotation angle by an adult woman relatively stronger than children, the regulation ridge of the second regulation member passes over the regulation ridge of the first regulation member and the second regulation member is elastically rotated, thereby the push button is fixed so as to be pushed, so that a user can conveniently operate and use the cosmetic container.

The present invention provides a cosmetic container having a push button blocked from being pushed within a regulation angle, which includes: a container body accommodated therein with a cosmetic material;

a discharge device installed at one side of the container body to discharge the cosmetic material to an outside;

a fixing member fixedly coupled to the container body and having a pressing groove and a pressing regulation step;

a rotating member rotatably provided outside the fixing member;

a first regulation member coupled to the fixing member and movable up and down;

a second regulation member fixedly coupled to and rotated together with the rotating member;

an elastic member vertically providing an elastic force to the first regulation member; and

a push button coupled to an upper side of the discharge device and having a discharge port, wherein

the first and second regulation members are formed with first and second regulation protrusions, respectively, in which the first regulation protrusion includes a first regulation ridge and a first regulation root, and the second regulation protrusion includes a second regulation ridge and a second regulation root such that the first and second regulation members are engaged with each other.

In addition, the container body may include a lower container body and an upper container body.

In addition, the discharge device may be formed as a pump that discharges the cosmetic material to the outside by pumping.

In addition, the fixing member may be formed on an outer periphery thereof with a fixing vertical groove, and the first regulation member may be formed on an inner periphery thereof with a fixing protrusion, so that the fixing member and the first regulation member are coupled to each other.

In addition, the rotating member may be formed at one side thereof with a discharge port insertion groove, and formed on an opposite side thereof with a button pushing groove.

In addition, the first regulation protrusion of the first regulation member elastically may come into close contact with the second regulation protrusion of the second regulation member by the elastic member.

In addition, the push button may be formed thereon with a pressing protrusion so as to be positioned over the pressing groove or the pressing regulation step of the fixing member by rotation of the rotating member.

In addition, when the rotating member is rotated, the second regulation ridge of the second regulation member may be prevented from moving over the first regulation ridge of the first regulation member and the second regulation member may return to an initial position, thereby maintaining a state of the push button prevented from being pushed; and when the rotating member is rotated strongly and the rotating member exceeds a predetermined rotation angle, the second regulation ridge of the second regulation member may move over the first regulation ridge of the first regulation member and the second regulation member may be rotated, thereby maintaining a state of the push button to be pushed.

According to the cosmetic container having a push button blocked from being pushed within a regulation angle according to the present invention, a fixing member is coupled to one side of the container body, a rotating member is rotatably coupled to the outside of the fixing member, and first and second regulation members are formed between the fixing member and the rotating member, in which each of the first and second regulation members is formed with a regulation protrusion including a regulation ridge and a regulation root so that the first and second regulation members are engaged with each other, the regulation protrusion of the first regulation member elastically comes into close contact with the regulation protrusion of the second regulation member by the elastic member the first regulation member coupled to the fixing member is fixed, upon rotation of the rotating member, and only the second regulation member coupled to the rotating member is rotated, and wherein the second regulation ridge of the second regulation member is prevented from moving over the first regulation ridge of the first regulation member and the second regulation member returns to an initial position, thereby maintaining a state of the push button prevented from being pushed, so that the push button can be prevented from being pushed by an undiscerning child. Further, when the rotating member is rotated beyond the predetermined rotation angle by an adult woman relatively stronger than children, the regulation ridge of the second regulation member moves over the regulation ridge of the first regulation member and the second regulation member is elastically rotated, thereby the push button is fixed so as to be pushed, so that the user can conveniently operate and use the cosmetic container.

### BRIEF DESCRIPTION OF THE DRAWINGS

FIG. 1 is a conventional dispenser container having a safety button structure.

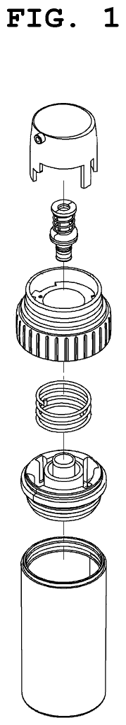

FIG. 2 is a perspective view of a cosmetic container according to one embodiment of the present invention.

FIG. 3 is an exploded perspective view of the cosmetic container according to one embodiment of the present invention.

FIG. 4 is a sectional view of the cosmetic container according to one embodiment of the present invention.

FIG. 5 is a sectional view showing that a cosmetic material is discharged to the outside by pressing a push button of the cosmetic container according to one embodiment of the present invention.

FIG. 6 is a sectional view showing that pressurization of the push button of the cosmetic container according to one embodiment of the present invention is released and the cosmetic material flows into a cylinder of a pump.

FIG. 7 is a partial perspective view showing that a rotating member is rotated in a state where pressurization of the push button of the cosmetic container according to one embodiment of the present invention is limited.

FIG. 8 is a partial perspective view showing that the rotating member of the cosmetic container according to one embodiment of the present invention is rotated so that the pressurization of the push button is allowed.

FIG. 9 is a partial sectional view showing that a second regulation member of the cosmetic container according to one embodiment of the present invention is rotated.

FIG. 10 is a partial sectional view showing that a second regulation member of the cosmetic container according to one embodiment of the present invention moves over the first regulation member while being rotated.

FIG. 11 is a partial sectional view showing that the first regulation member and the second regulation member of the cosmetic container according to one embodiment of the present invention are engaged with each other.

### DETAILED DESCRIPTION OF THE INVENTION

Technical objects implemented by the present invention will be apparent from the following preferred embodiments. Hereinafter, one embodiment of a cosmetic container having a push button blocked from being pushed within a regulation angle according to the present invention will be described in detail with reference to the accompanying drawings as follows.

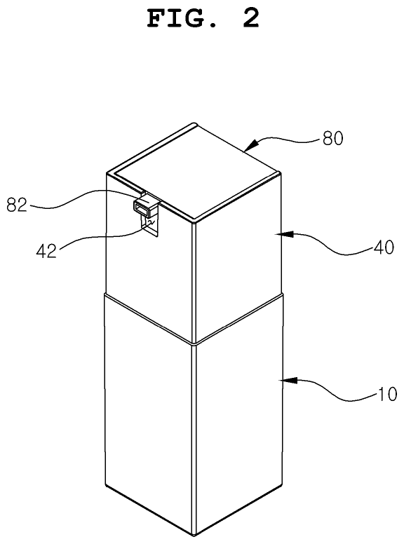

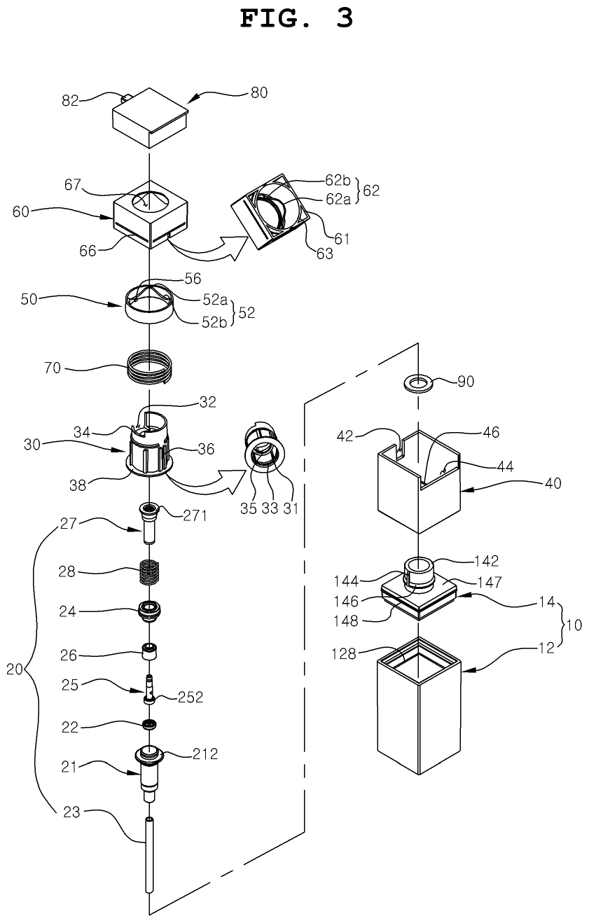

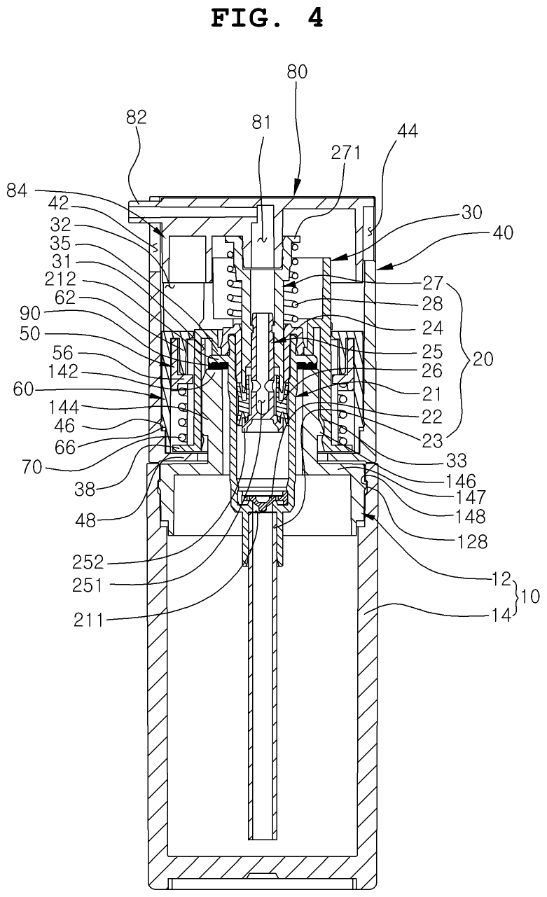

FIG. 2 is a perspective view of a cosmetic container according to one embodiment of the present invention. FIG. 3 is an exploded perspective view of the cosmetic container according to one embodiment of the present invention. FIG. 4 is a sectional view of the cosmetic container according to one embodiment of the present invention.

As shown in FIG. 3, the cosmetic container having a push button blocked from being pushed within a regulation angle according to one embodiment of the present invention includes: a container body 10 accommodated therein with a cosmetic material; a discharge device 20 installed at one side of the container body 10 to discharge the cosmetic material to an outside; a fixing member 30 fixedly coupled to the container body 10 and having a pressing groove 32 and a pressing regulation step 34; a rotating member 40 rotatably provided outside the fixing member 30; a first regulation member 50 coupled to the fixing member 30 and movable up and down; a second regulation member 60 fixedly coupled to and rotated together with the rotating member 40; an elastic member 70 vertically providing an elastic force to the first regulation member 50; and a push button 80 coupled to an upper side of the discharge device 20 and having a discharge port 82.

The container body 10 is accommodated therein with a cosmetic material, and includes a lower container body 12 and an upper container body 14 that are coupled to each other. Alternatively, the lower container body 12 and the upper container body 14 of the container body 10 may be integrally formed with each other.

As shown in FIG. 3, the lower container body 12 has an open top, is filled therein with a liquid or gel cosmetic material, and is formed on a peripheral surface thereof with a coupling groove 128.

The upper container body 14 is formed at a top thereof with an inlet portion 142 in which, a fixing protrusion 144 for restricting a rotation of the fixing member 30 is vertically formed on an outer periphery of the inlet portion 142, a fixing protrusion wheel 146 having a ring shape is formed at a lower portion of the fixing protrusion 144 to prevent the fixing member 30 from being separated from the upper container body 14.

A coupling protrusion 148 is formed on a lower inner peripheral surface of the upper container body 14 and coupled to a coupling groove 128 of the lower container body 12.

The discharge device 20 is installed at the inlet portion 142 of the container body 10 to discharge the cosmetic material accommodated in the container body 10 to the outside.

The discharge device 20 may be formed as a pump that discharges the cosmetic material to the outside by pumping.

As shown in FIG. 4, the discharge device 20 includes a housing 21 formed on one side thereof with a cosmetic suction port 211, a suction valve 22 for opening and closing the cosmetic suction port 211 of the housing 21, a suction tube 23 coupled to a lower portion of the housing 21 to suck the cosmetic material into the housing 21, a fixed bushing 24 fixedly coupled to an upper portion of the housing 21, a piston support 25 provided inside the housing 21 and vertically moved inside the housing 21, a piston 26 fitted to an outside of the piston support 25 and coming into close contact with an inner surface of the housing 21, a stem 27 coupled to an upper portion of the piston support 25, and a spring 28 for elastically supporting the stem 27.

The housing 21 is coupled through the inlet portion 142 of the container body 10, and a seating step 212 is formed at an upper outer periphery of the housing 21 so as to be seated on a top of the inlet portion 142 of the container body 10. A sealing ring 90 formed of an elastic material may be further provided between the seating step 212 and the inlet portion 142 to improve a sealing force of the container body 10.

The suction valve 22 is installed in the cosmetic suction port 211 of the housing 21 to serve to introduce or block the cosmetic material accommodated in the container body 10 into the housing 21. The suction tube 23 extends to the lower portion of the housing 21 and is positioned inside the container body 10.

The fixed bushing 24 seals the inside of the housing 21 and encloses an outer periphery of the stem 27.

The piston support 25 is moved up and down by the stem 27, is formed on an outer periphery thereof with an inflow passage 251 through which the cosmetic material temporarily stored in the housing 21 passes, and is formed at a lower portion thereof with a locking portion 252 to prevent the piston 26 from being separated downward.

The piston 26 is fitted to the outside of the piston support 25 and moved up and down together with the piston support 25.

The piston support 25 is coupled to a lower portion of the stem 27, the push button 80 is coupled to an upper portion thereof.

A lower portion of the spring 28 is seated on a top of the fixed bushing 24, and an upper portion thereof comes into close contact with a protrusion 271 formed on an upper outer periphery of the stem 27.

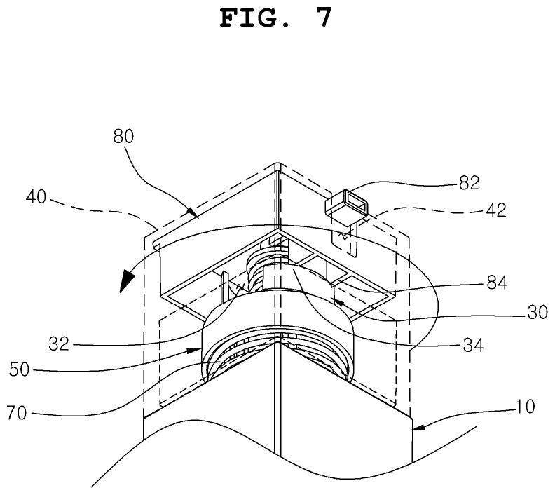

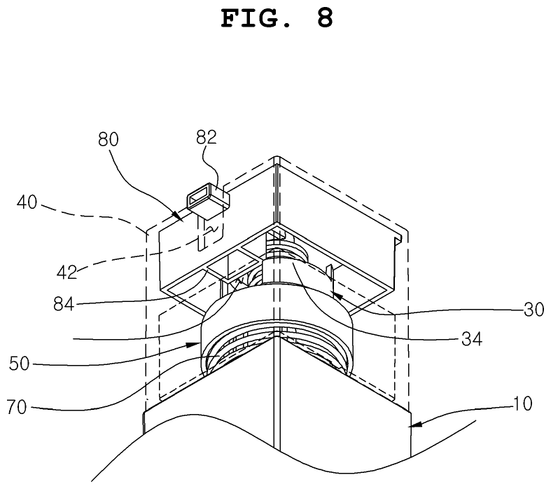

FIG. 7 is a partial perspective view showing that a rotating member is rotated in a state where pressurization of the push button of the cosmetic container according to one embodiment of the present invention is limited. FIG. 8 is a partial perspective view showing that the rotating member of the cosmetic container according to one embodiment of the present invention is rotated so that the pressurization of the push button is allowed.

As shown in FIG. 4, the fixing member 30 is fixedly coupled to an outer side of the inlet portion 142 of the container body 10.

As shown in FIG. 3, a fixing groove 31 and a fixing recess 33 are formed on an inner periphery of the fixing member 30, in which the fixing groove 31 is formed vertically and coupled with the fixing protrusion 144 of the container body 10, and the fixing recess 33 is formed below the fixing groove 31 and coupled to the fixing protrusion wheel 146 of the container body 10. Accordingly, the fixing member 30 is prevented from being idle or separated from the container body 10.

In addition, a pushing portion 35 is formed on the inner periphery of the fixing member 30, in which, as shown in FIG. 4, when the fixing member 30 is assembled to an outer side of the inlet portion 142 of the container body 10, the pushing portion 35 strongly fixes the discharge device 20 by pushing an upper surface of the seating step 212 of the discharge device 20.

The pressing groove 32 is formed on an upper side of the fixing member 30, and the pressing regulation step 34 is formed adjacent to the pressing groove 32.

The pressing groove 32 serves as a space for allowing a pressing protrusion 84 of the push button 80 to be moved vertically. As shown in FIG. 7, when the pressing protrusion 84 of the push button 80 is positioned on a top of the pressing regulation step 34, the push button 80 is prevented from being pushed. In addition, the pressing regulation step 34 limits movements of the pressing protrusion 84 of the push button 80 downward. As shown in FIG. 8, when the pressing protrusion 84 of the push button is positioned over the pressing groove 32, the push button 80 is allowed to be pushed.

As shown in FIG. 3, a fixing vertical groove 36 is formed on an outer periphery of the fixing member 30, in which the fixing vertical groove 36 is coupled to a fixing protrusion 56 formed on the first regulation member 50.

As shown in FIG. 4, an outer protrusion 38 protrudes outward from a lower outer periphery of the fixing member 30 and a lower end of the elastic member 70 is seated on the outer protrusion 38.

The rotating member 40 has a shape opened at upper and lower portions thereof, and is rotatably formed outside the fixing member 30.

As shown in FIG. 3, the rotating member 40 is formed at one side thereof with a discharge port insertion groove 42 into which the discharge port 82 of the push button 80 is inserted. A button pushing groove 44 is formed on an opposite side of the discharge port insertion groove 42, in which one side of the push button 80 is exposed to the outside through the button pushing groove 44 so that a user easily pushes the push button 80.

A fastening groove 46 is formed on the inner peripheral surface of the rotating member 40 so as to be fixedly coupled to a fastening protrusion 66 formed on an outer peripheral surface of the second regulation member 60.

An inner protrusion 48 protrudes inward from a lower inner peripheral surface of the rotating member 40. As shown in FIG. 4, the inner protrusion 48 is inserted between a shoulder 147 formed on an outer side of the inlet portion 142 of the upper container body 14 and an outer protrusion 38 of the fixing member 30, so that the rotating member 40 is prevented from being separated from the container body 10 and the fixing member 30.

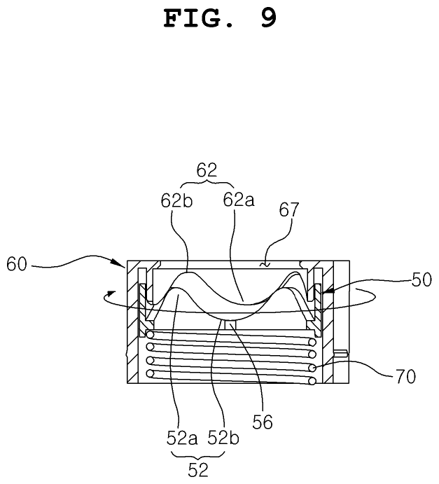

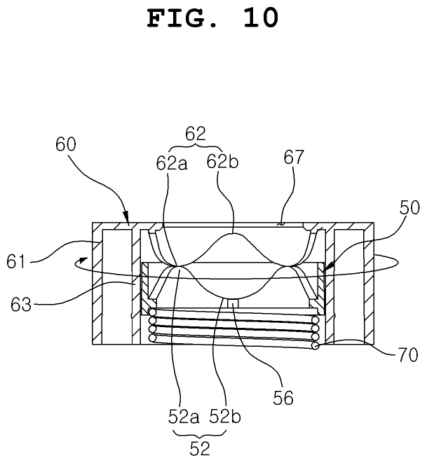

FIG. 9 is a partial sectional view showing that a second regulation member of the cosmetic container according to one embodiment of the present invention is rotated. FIG. 10 is a partial sectional view showing that a second regulation member of the cosmetic container according to one embodiment of the present invention moves over the first regulation member while being rotated. FIG. is a partial sectional view showing that the first regulation member and the second regulation member of the cosmetic container according to one embodiment of the present invention are engaged with each other.

The first regulation member 50 is coupled while surrounding the outer periphery of the fixing member 30, and coupled to the fixing member 30 and movable up and down.

As shown in FIG. 3, a first regulation protrusion 52 is formed on an inner periphery of the first regulation member 50, in which the first regulation protrusion 52 includes a first regulation ridge 52a protruding upward and a first regulation root 52b recessed downward, and the first regulation ridge 52a and the first regulation root 52b of the first regulation protrusion 52 are formed in smooth curved shapes and connected alternately to each other.

The fixing protrusion 56 protrudes inward from the inner periphery of the first regulation protrusion 52 so as to be coupled to the fixing vertical groove 36 of the fixing member 30.

In addition, the first regulation member 50 is elastically supported upward by the elastic member 70 to be described later.

The second regulation member 60 is fixedly coupled to the inside of the rotating member 40 and rotated together with the rotating member 40.

As shown in FIG. 3, a polygonal outer wall 61 is formed on the second regulation member 60, a cylindrical inner wall 63 is formed inside the outer wall 61, and a second regulation protrusion 62 is formed inside the inner wall 61.

A through-hole 67 is formed in a center of the second regulation member 60, and the fixing member 30 passes through the through-hole 67.

As shown in FIG. 4, an upper portion of the first regulation member 50 is inserted between the second regulation protrusion 62 and the inner wall 63 of the second regulation member 60, and the fastening protrusion 66 is formed on an outer peripheral surface of the outer wall 61 so as to be coupled to the fastening groove 46 of the rotating member 40.

The second regulation protrusion 62 has a shape corresponding to the first regulation protrusion 52 of the first regulation member 50. As shown in FIG. 3, the second regulation protrusion 62 includes a second regulated ridge 62a protruding relatively downward and a second regulation root 62b formed by recessed relative upward, and the second regulation ridge 62a and the second regulation root 62b of the second regulation protrusion 62 are formed in smooth curved shapes and connected alternately to each other.

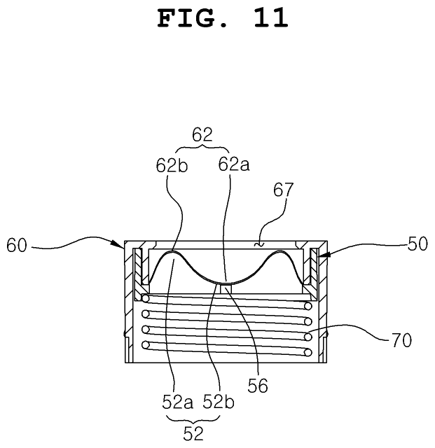

In other words, as shown in FIG. 11, the first regulation ridge 52a of the first regulation protrusion 52 is inserted into the second regulation root 62b of the second regulation protrusion 62, the second regulation ridge 62a of the second regulation protrusion 62 is inserted into the first regulation root 52b of the first regulation protrusion 52, and accordingly, the first regulation protrusion 52 and the second regulation protrusion 62 are engaged with each other.

The first regulation member 50 and the second regulation member 60 are positioned between the fixing member 30 and the rotating member 40.

In addition, the first regulation protrusion 52 of the first regulation member 50 elastically comes into close contact with the second regulation protrusion 62 of the second regulation member 60 by the elastic member 70.

In other words, when the rotating member 40 is gripped and rotated, the first regulation member 50, which is coupled the fixed member 30 to be movable vertically only, is not rotated, and only the second regulation member 60 coupled to the rotating member 40 is rotated. At this time, as shown in FIG. 9, the second regulation ridge 62a of the second regulation member 60 is prevented from moving over the first regulation ridge 52a of the first regulation member 50 within a predetermined rotation angle. When the rotating member 40 is released in the above state, since the first regulation member 50 is elastically supported upward by the elastic member 70, the second regulation member 60 is returned to an initial position by an upwardly pushed force of the first regulation member 50, thereby maintaining a state of the push button 80 prevented from being pushed. Accordingly, an undiscerning child is prevented from pushing the push button 80 because the child cannot fully rotate the rotating member 40.

However, when the rotating member 60 is rotated more strongly by an adult woman that is relatively stronger than children and rotated beyond the predetermined rotation angle, as shown in FIG. 10, the first regulation member 50 elastically moves downward, and the second regulation ridge 62a of the second regulation member 60 moves over the first regulation ridge 52a of the first regulation member 52. At the same time, the second regulation member 60 is elastically rotated by the force upwardly pushed by the first regulation member 50, the push button 80 is in a state to be pushed. Accordingly, an adult user may operate and use the cosmetic container conveniently.

As described above the elastic member 70 vertically provides an elastic force to the first regulation member 50.

As shown in FIG. 4, the elastic member 70 has one end coming into close contact with the top of the outer protrusion 38 of the fixing member 30, and the other end coming into close contact with the lower surface of the first regulation protrusion 52 of the first regulation member 50, so that the first regulation member 50 is elastically supported upward.

The push button 80 is coupled to one side of the discharge device 20 so that the pushing pressure is transferred to the discharge device 20.

As shown in FIG. 4, a discharge passage 81 for moving the cosmetic material pumped by the discharge device 20 is formed in a center of the push button 80, the discharge port 82 for discharging the cosmetic material moved through the discharge passage 81 to the outside is formed one side of the push button 80.

The pressing protrusion 84 is formed at a lower portion of the push button 80 so that the push button 80 is restricted or allowed to be pushed.

The pressing protrusion 84 of the push button 80, as shown in FIGS. 7 and 8, is selectively positioned on the pressing groove 32 and the pressing regulation step 34 of the fixing member 30 by the rotation of the rotating member 40. Accordingly, the pushing of the push button 80 is restricted or allowed.

The method of assembling the cosmetic container configured in the above manner and according to one embodiment of the present invention will be described with reference to the accompanying drawings.

In order to assemble the cosmetic container according to one embodiment of the present invention, first, a liquid or gel cosmetic material is filled in the lower container body 12 of the container body 10, and the upper container body 14 is coupled to the upper portion of the lower container body 12, as shown in FIG. 3. Alternatively, in the case that the lower container body 12 and the upper container body 14 of the container body 10 are integrally formed with each other, the container body 10 is filled with the cosmetic material through the inlet portion 142.

Next, as shown in FIG. 4, the discharge device 20, which includes the housing 21, the suction valve 22, the suction tube 23, the fixed bushing 24, the piston support 25, the piston 26, the stem 27, and the spring 28, is installed to the inlet portion 142 of the container body 10.

In the case that the sealing ring 90 is further provided between the inlet portion 142 of the container body 10 and the seating step 212 of the housing 21, the sealing ring 90 is placed on the top of the inlet portion 142 of the container body 10, and the discharge device 20 is installed to the inlet portion 142 of the container body 10.

Next, in order to couple the fixing member 30, the rotating member 40, the first and second regulation members 50 and 60, and the elastic member 70, the fixing member 30 is inserted to the rotating member 40 from the top to allow the outer protrusion 38 of the fixing member 30 to be seated on the upper surface of the inner protrusion 48 of the rotating member 40, the elastic member 70 is fitted to the outside of the fixing member 30, and the first regulation member 50 and the second regulation member 60 are sequentially inserted and coupled between the fixing member 30 and the rotating member 40.

The fixing protrusion 56 of the first regulation member 50 is inserted into the fixing vertical groove 36 of the fixing member 30, the upper portion of the first regulation member 50 is inserted between the second regulation protrusion 62 and the inner wall 63 of the second regulation member 60, and the fastening protrusion 66 of the second regulation member 60 is coupled to the fastening groove 46 of the rotating member 40.

At the same time, as shown in FIG. 11, the first regulation protrusion 52 of the first regulation member 50 and the second regulation protrusion 62 of the second regulation member 60 are engaged with each other. In other words, the first regulation ridge 52a of the first regulation protrusion 52 is inserted into the second regulation root 62b of the second regulation protrusion 62, and the second regulation ridge 62a of the second regulation protrusion 62 is inserted into the first regulation root 52b of the first regulation protrusion 52.

Next, the coupling member 30 coupled in the above manner is coupled to the outside of the inlet portion 142 of the container body 10, in which the fixing protrusion 144 and the fixing protrusion wheel 146 of the container body 10 are coupled to the fixing groove 31 and the fixing recess 33 of the fixing member 30, respectively, to fix the fixing member 30 to the container body 10, and the pushing portion 35 of the fixing member 30 strongly pushes the upper surface of the seating step 212 of the discharge device 20 to fix the discharge device 20.

Finally, the push button 80 is coupled to the upper side of the rotating member 60, in which the push button 80 is coupled to the stem 27 of the discharge device 20 while the discharge port 82 of the push button 80 is inserted into the discharge port insertion groove 42 of the rotating member 40, and thus the assembly of the cosmetic container according to one embodiment of the present invention is completed.

The method of using the cosmetic container assembled in the above manner and according to one embodiment of the present invention will be described with reference to the accompanying drawings.

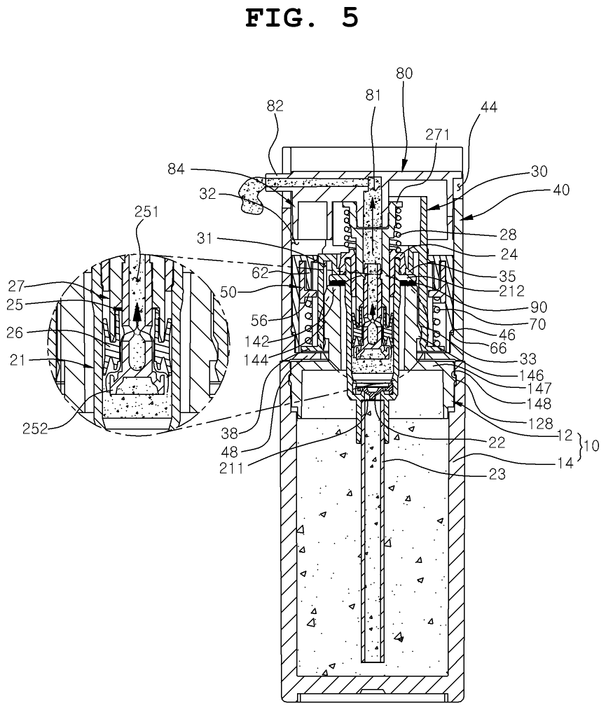

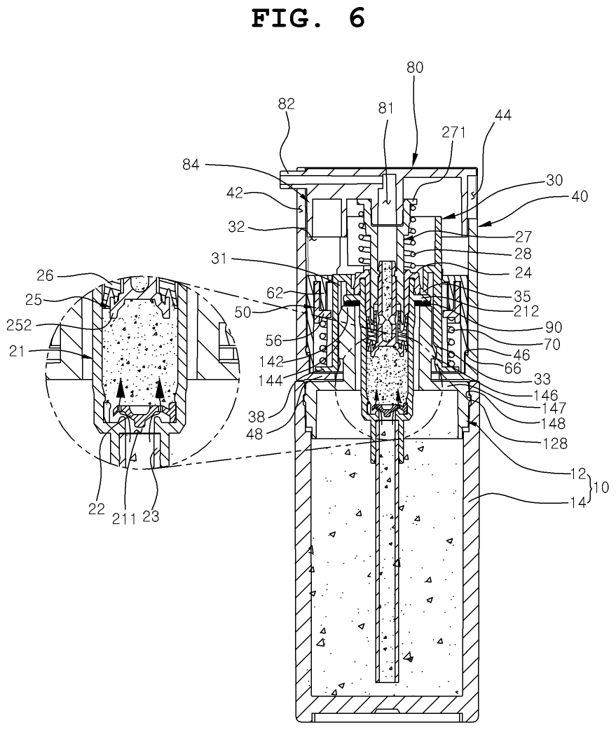

FIG. 5 is a sectional view showing that a cosmetic material is discharged to the outside by pressing a push button of the cosmetic container according to one embodiment of the present invention. FIG. 6 is a sectional view showing that pressurization of the push button of the cosmetic container according to one embodiment of the present invention is released and the cosmetic material flows into a cylinder of a pump.

In order to use the cosmetic container according to one embodiment of the present invention, first, as shown in FIG. 7, the rotating member 40 is gripped and rotated in one direction.

When the rotating member 40 is rotated, the first regulation member 50 fixedly coupled to the fixing member 30 is not rotated, and only the second regulation member 60 coupled to the rotating member 40 is rotated together with the rotating member 40. As shown in FIG. 9, when the second regulation ridge 62a of the second regulation member 60 escapes from the first regulation root 52b of the first regulation member 50 and pushes the first regulation ridge 52a downward, the first regulation member 50 is moved downward while compressing the elastic member 70.

When the rotating member 40 is released before the second regulation ridge 62a of the second regulation member 60 completely moves over the first regulation ridge 52a of the first regulation member 50, the first regulation member 50 rises upward due to a repulsive force of the elastic member 70, and the first regulation ridge 52a of the first regulation member 50 pushes the second regulation ridge 62a of the second regulation member 60 to rotate the second regulation member 60 to the initial position, thereby maintaining a state of the push button 80 prevented from being pushed.

As shown in FIG. 10, when the rotating member 40 is rotated more strongly, the first regulation member 50 continues to move downward while being compressed, and the second regulation ridge 62a of the second regulation member 60 moves over the first regulation ridge 52a of the first regulation member 52. As the first regulation member 50 rises upward due to the repulsive force of the elastic member 70, the first regulation ridge 52a of the first regulation member 50 pushes and rotates the second regulation ridge 62a of the second regulation member 60. Accordingly, the rotating member 40 coupled to the second regulation member 60 and the push button 80 inserted inside the rotating member 40 are rotated, and the pressing protrusion 84 of the push button 80 is positioned over the pressing groove 32 of the fixing member 30 as shown in FIG. 8, so that the push button 80 is in a state to be pushed.

Then, as shown in FIG. 5 the push button 80 is pushed to operate the discharge device 20, so that the cosmetic material accommodated in the container body 10 is discharged to the outside.

The operational process of the discharge device 20 will be described in detail as follows.

When the push button 80 is pushed, the stem 27 of the discharge device 20 coupled to the push button 80, and the piston support 25 coupled to the lower portion of the stem 27 are moved downward.

Since the piston 26 of the discharge device 20 comes into close contact with the inner surface of the housing 21, only the piston support 25 moves downward, and a gap is generated between the piston support 25 and the piston 26 as shown in the enlarged view of FIG. 5, so that the discharge path for the cosmetics is generated.

Then, when the push button 80 is further pushed, the lower end of the stem 27 moving downward by the push button pushes the piston 26, so that the piston 26 moves downward together with the piston support 25, thereby reducing a volume inside the housing 21. Accordingly, the suction valve 22 closes the cosmetic suction port 211 by the discharging pressure in the housing 21, and simultaneously, the cosmetic material accommodated in the housing 21 is discharged between the piston support 25 and the piston 26, passes through the inflow passage 251 of the piston support 25, passes through the discharge passage 81 of the push button 80, and is discharged to the discharge port 82.

Then, as shown in FIG. 6, when the pressurization of the push button 80 is released, the stem 27 is moved upward by the elasticity of the spring 28 for elastically supporting the stem 27 of the discharge device 20, and the piston support 25 coupled to the lower side of the stem 27 is also moved upward. At this time, the locking portion 252 of the piston support 25 pulls the piston 26 upward and the gap between the piston support 25 and the piston 26 is blocked, so that the piston support 25 and the piston 26 are moved upward together, so that a volume inside the housing 21 increases, thereby generating a vacuum pressure.

As shown in the partially enlarged view of FIG. 6, the suction valve 22 is lifted by the vacuum pressure generated inside the housing 21, and the cosmetic suction port 211 formed on the bottom surface of the housing 21 is opened, so that the cosmetic material accommodated in the container body 10 is introduced into the housing 21 through the suction tube 23 and the cosmetic suction port 211.

After the make-up is completed, when the rotating member 40 is rotated in an opposite direction, the pressing protrusion 84 of the push button 80 is positioned above the pressing regulation step 34 of the fixing member 30 to prevent the push button 80 from being pushed, and then the cosmetic container is stored or carried.

Herein, the description of the present invention is merely one embodiment for carrying out the cosmetic container having the push button blocked from being pushed within the regulation angle, and the present invention is not limited to the embodiment. Exemplary embodiments have been proposed and set forth in the aforementioned description, however the present invention should not be construed as limited thereto, and it will be apparent to those having ordinary skill in the art in that many different substitutions, deformations and modifications are available within the scope without departing from the invention.

What is claimed is:

1. A cosmetic container having a push button blocked from being pushed within a regulation angle, the cosmetic container comprising:
a container body accommodated therein with a cosmetic material;
a discharge device installed at one side of the container body to discharge the cosmetic material to an outside;
a fixing member fixedly coupled to the container body and having a pressing groove and a pressing regulation step;
a rotating member rotatably provided outside the fixing member;
a first regulation member coupled to the fixing member and movable up and down;
a second regulation member fixedly coupled to the rotating member to rotate together with the rotating member;
an elastic member vertically providing an elastic force to the first regulation member; and
a push button coupled to an upper side of the discharge device and having a discharge port, wherein the first and second regulation members are formed with first and second regulation protrusions, respectively, in which the first regulation protrusion includes a first regulation ridge and a first regulation root, and the second regulation protrusion includes a second regulation ridge and a second regulation root such that the first and second regulation members are engaged with each other.

2. The cosmetic container of claim 1, wherein the container body includes a lower container body and an upper container body.

3. The cosmetic container of claim 1, wherein the discharge device is configured as a pump that discharges the cosmetic material to the outside by pumping.

4. The cosmetic container of claim 1, wherein the fixing member is formed on an outer periphery thereof with a fixing vertical groove, and the first regulation member is formed on an inner periphery thereof with a fixing protrusion, so that the fixing member and the first regulation member are coupled to each other.

5. The cosmetic container of claim 1, wherein the rotating member is formed at one side thereof with a discharge port insertion groove, and formed on an opposite side thereof with a button pushing groove.

6. The cosmetic container of claim 1, wherein the first regulation protrusion of the first regulation member elastically comes into close contact with the second regulation protrusion of the second regulation member by the elastic member.

7. The cosmetic container of claim 1, wherein the push button is formed thereon with a pressing protrusion so as to be positioned over the pressing groove or the pressing regulation step of the fixing member by rotation of the rotating member.

8. The cosmetic container of claim 1, wherein, when the rotating member is rotated, the second regulation ridge of the second regulation member is prevented from moving over the first regulation ridge of the first regulation member and the second regulation member returns to an initial position thereof so that the push button is prevented from being pushed; and
when the rotating member is rotated strongly such that the rotating member exceeds a predetermined rotation angle, the second regulation ridge of the second regulation member moves over the first regulation ridge of the first regulation member and the second regulation member is rotated, so that the push button is allowed to be pushed.
